(19) United States
(12) Patent Application Publication
(10) Pub. No.: US 2022/0207538 A1
(43) Pub. Date: Jun. 30, 2022

(54) ATTENTIVENESS TRACKING AND COORDINATION OF CALL CENTER AGENTS

(71) Applicant: ChatLingual, Inc., Denver, CO (US)

(72) Inventors: Mildred Ann Booher, Broomfield, CO (US); John Eric Bukowski, Denver, CO (US); Justin Custer, Denver, CO (US); Josh Meyer, Denver, CO (US); Dylan Slack, Denver, CO (US)

(21) Appl. No.: 17/556,014

(22) Filed: Dec. 20, 2021

Related U.S. Application Data
(60) Provisional application No. 63/131,059, filed on Dec. 28, 2020.

(51) Int. Cl. G06Q 30/00; G06Q 10/06; G06F 40/279; H04M 3/51; H04L 51/046; H04L 51/00; H04L 51/02

(52) U.S. Cl. CPC G06Q 30/016; G06Q 10/06398; G06F 40/279; H04M 3/5191; H04M 2203/401; H04L 51/046; H04L 51/16; H04L 51/02; H04M 3/5175

(57) ABSTRACT

Systems and methods are provided for controlling interactions between customers and agents. One embodiment is a system that includes an interface which receives a request to initiate a conversation. The system also includes a controller that acts as a message broker for the conversation by initiating a message stream between a customer device and an agent device, and records a time from receipt of each customer message to receipt of a corresponding agent response during the message stream. The controller also identifies an issue that the conversation is directed to, adjusts a permitted time period for agent responses based on a complexity of the issue, calculates an effectiveness score for the agent based on a number of agent responses that were provided within the permitted time period, updates a profile for the agent with the effectiveness score, and uses the effectiveness score as criteria for selecting the agent.

### FIELD

The disclosure relates to the field of customer service, and in particular, to managing connections between agents and customers.

### BACKGROUND

Call centers are customer service entities that operate on behalf of one or more clients. For example, a call center may provide customer service relating to products or services sold by a client. During a customer service interaction, a customer contacts the call center and is connected with a Customer Service Agent (CSA) acting on behalf of the client. The CSA responds to concerns of the customer pertaining to an issue with a product or service of the client, and attempts to resolve the issue.

The attentiveness of CSAs during customer service interactions may be checked for compliance with a metric known as Service Level Agreement (SLA) response time. This metric provides insight into the quality of customer service provided by a CSA, because the ability to swiftly respond to an inquiry often correlates positively with customer ratings and/or reviews.

Traditionally, SLA response time has been measured based on the time elapsed between an initial inquiry (or subsequent message) of a customer and a reply generated by the CSA. If the reply of the CSA is within a predefined period of time after the inquiry, then the response delay is considered acceptable. Determining a ratio of acceptable response times to unacceptable response times for multiple inquiries results in a percentage score for the CSA. A CSA with a higher percentage score is assumed to perform at a higher level than a CSA with a lower percentage score. It is therefore not uncommon to assign a CSA to one of multiple categories (e.g., “poor,” “satisfactory,” “exemplary,” etc.) based on their percentage score. However, the metric of SLA response time fails to adequately determine the responsiveness of actions taken by a CSA in addressing the dynamic and diverse range of issues encountered by customers.

Hence, those who optimize interactions between customers and CSAs continue to seek out enhanced systems and methods for achieving these goals.

### SUMMARY

Embodiments described herein benefit from the insight that while the fundamental SLA measurement is simple to record, it is limited in its application. The acceptable response time, which is a cornerstone of the measurement, is static in nature. Furthermore, the acceptable response time is susceptible to being measured inaccurately after the fact. Thus, even though an SLA measurement can provide limited insights when comparing agents within a single call center, this solution is a rudimentary, one-size-fits-all approach that does not account for differences relating to inquiry complexity or initial customer sentiment.

The embodiments described herein provide a technical benefit by enabling granular analysis of the actions of any number of CSAs. These embodiments implement an Agent Effectiveness Score (AES) that is dynamically calculated (e.g., in real-time), in order to account for the behavior of CSAs across a wide range of customers and issues types. This dynamic, multi-metric score exhibits a high granularity, in that it is capable of accounting for differences in individual interactions that would otherwise unfairly benefit or penalize a CSA servicing an issue. Furthermore, by utilizing a scoring system that accounts for issue complexity and other factors, the AES enables comparison of CSAs across a variety of call centers, enabling better tracking and deployment of CSA resources to customers. This in turn provides a technical benefit by enhancing the overall level of service provided to customers.

One embodiment is a system for controlling interactions between customers and agents. The system includes an interface which receives a request to initiate a conversation between a customer and an agent of a call center. The system also includes a controller that acts as a message broker for the conversation by initiating a message stream between a customer device and an agent device, and records a time from receipt of each customer message to receipt of a corresponding agent response during the message stream. The controller also identifies an issue that the conversation is directed to, adjusts a permitted time period for agent responses based on a complexity of the issue, calculates an effectiveness score for the agent based on a number of agent responses that were provided within the permitted time period during the conversation, updates a profile for the agent with the effectiveness score, and uses the effectiveness score as criteria for selecting the agent for participation in future conversations.

A further embodiment is a method for controlling interactions between customers and agents. The method includes receiving a request to initiate a conversation between a customer and an agent of a call center, acting as a message broker for the conversation by initiating a message stream between a customer device and an agent device, and recording a time from receipt of each customer message to receipt of a corresponding agent response during the message stream. The method also includes identifying an issue that the conversation is directed to, adjusting a permitted time period for agent responses based on a complexity of the issue, calculating an effectiveness score for the agent based on a number of agent responses that were provided within the permitted time period during the conversation, updating a profile for the agent with the effectiveness score, and using the effectiveness score as criteria for selecting the agent for participation in future conversations.

Yet another embodiment is a non-transitory computer readable medium embodying programmed instructions which, when executed by a processor, are operable for performing a method for controlling interactions between customers and agents. The method includes receiving a request to initiate a conversation between a customer and an agent of a call center, acting as a message broker for the conversation by initiating a message stream between a customer device and an agent device, and recording a time from receipt of each customer message to receipt of a corresponding agent response during the message stream. The method also includes identifying an issue that the conversation is directed to, adjusting a permitted time period for agent responses based on a complexity of the issue, calculating an effectiveness score for the agent based on a number of agent responses that were provided within the permitted time period during the conversation, updating a profile for the agent with the effectiveness score, and using the effectiveness score as criteria for selecting the agent for participation in future conversations.

Other illustrative embodiments (e.g., methods and computer-readable media relating to the foregoing embodiments) may be described below. The features, functions, and advantages that have been discussed can be achieved independently in various embodiments or may be combined in yet other embodiments further details of which can be seen with reference to the following description and drawings.

### DESCRIPTION OF THE DRAWINGS

Some embodiments of the present disclosure are now described, by way of example only, and with reference to the accompanying drawings. The same reference number represents the same element or the same type of element on all drawings.

FIG. 1 is a block diagram of a customer service network in an illustrative embodiment.

FIG. 2 is a flowchart illustrating a method for operating an issue coordination server to initiate a conversation between a customer and an agent in an illustrative embodiment.

FIG. 3 is a flowchart depicting a method of selecting an agent for a conversation in an illustrative embodiment.

FIG. 4 is a flowchart depicting a method of tracking an effectiveness score of an agent in an illustrative embodiment.

FIG. 5 is a further flowchart depicting a method of tracking an effectiveness score of an agent in an illustrative embodiment.

FIG. 6 is a schematic diagram depicting an issue coordination server handling a conversation between an agent device and a customer device in an illustrative embodiment.

FIG. 7 is a message diagram depicting communications with an issue coordination server during a conversation between an agent device and a customer device in an illustrative embodiment.

FIG. 8 depicts criteria for identifying issue complexity in an illustrative embodiment.

FIG. 9 depicts message-response pairs for calculating the effectiveness score of an agent during a conversation in an illustrative embodiment.

FIGS. 10-11 depict Graphical User Interfaces (GUIs) that summarize customer service metrics in illustrative embodiments.

FIG. 12 depicts an illustrative computing system operable to execute programmed instructions embodied on a computer readable medium.

### DESCRIPTION

The figures and the following description depict specific illustrative embodiments of the disclosure. It will thus be appreciated that those skilled in the art will be able to devise various arrangements that, although not explicitly described or shown herein, embody the principles of the disclosure and are included within the scope of the disclosure. Furthermore, any examples described herein are intended to aid in understanding the principles of the disclosure, and are to be construed as being without limitation to such specifically recited examples and conditions. As a result, the disclosure is not limited to the specific embodiments or examples described below, but by the claims and their equivalents.

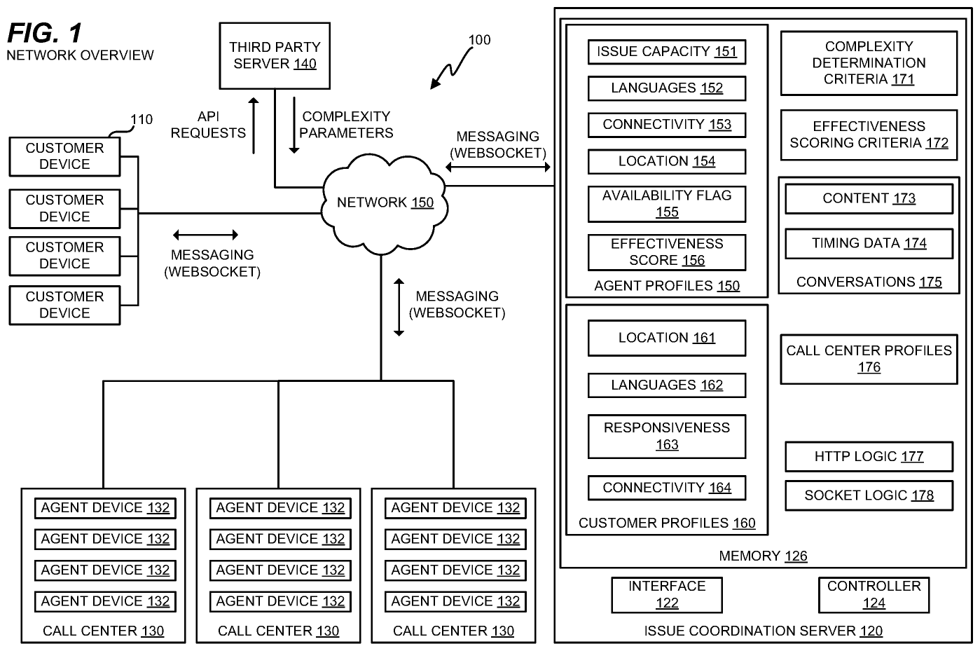

FIG. 1 is a block diagram of a customer service network 100 in an illustrative embodiment. Customer service network 100 comprises any combination of devices and/or components that receive requests from customers, select agents for handling the requests, and initiate messaging streams between customers and corresponding agents in order to resolve issues indicated in the requests.

In this embodiment, customer service network 100 includes customer devices 110 (e.g., desktop computers, laptops, tablets, cellular phones, etc.). The customer devices 110 send requests to issue coordination server 120 describing issues encountered by customers. As used herein, an “issue” comprises a need for information or investigation relating to a product or service utilized by a customer. Thus, depending on the product or service, an “issue” may comprise a need to change a flight reservation made by the customer, a difficulty with customizing settings in a Basic Input Output System (BIOS) of a computer purchased by the customer, a difficulty accessing an online service used by the customer, etc.

The requests sent by customer devices 110 may comprise Hypertext Transfer Protocol (HTTP) requests, Short Message Service (SMS) requests, Voice over Internet Protocol (VoIP) requests, etc. In one embodiment, issue coordination server 120 receives hundreds or thousands of requests per second, and performs processing of the requests in parallel and/or asynchronously for hundreds of thousands of customers and tens of thousands of agents in order to enhance operational speed. A controller 124 of the issue coordination server 120 processes these messages as part of managing the operations of issue coordination server 120. The controller 124 may be implemented, for example, as custom circuitry, as a hardware processor executing programmed instructions, or some combination thereof.

Controller 124 categorizes the underlying issue that each request relates to. Depending on embodiment, controller 124 may categorize the issue by analyzing a referring website or cookie mentioned in the request, based on natural language analysis of a title of the request, or based on other criteria. Controller 124 may further review the request to identify a product or service that the issue relates to, the name of a client that provides the product or service, etc.

In one embodiment, controller 124 accesses memory 126 (e.g., Random Access Memory (RAM), flash memory, a hard disk, etc.) for complexity determination criteria 171 (e.g., a keyword list) and utilizes the criteria to determine an amount of complexity for the issue at hand. For example, controller 124 may determine the complexity of an issue by identifying a set of keywords in the request, consulting correlations in memory 126 between keywords and complexities, identifying a highest complexity correlated with the set of keywords, and assigning the highest complexity to the issue. Metrics for determining complexity may be provided by third party servers 140, such as servers operated by clients of issue coordination server 120.

Controller 124 may further access or update memory 126 to identify or update a customer profile 160 based on the request. In this embodiment, a customer profile 160 may indicate a geographic location 161 of the customer, languages 162 understood by the customer, an expected responsiveness 163 (e.g., time for the customer to reply) to agent responses, and a connectivity 164 (e.g., a connection speed, and/or supported modes of communication) of the customer.

Based on the customer profile 160 and the category of issue, the controller 124 reviews call center profiles 176 to select a call center 130 for servicing the request. In this embodiment, the call center 130 is chosen based on its geographic proximity to the customer device 110 (as indicated in a call center profile 176), in order to enhance the likelihood of cultural similarities existing between the customer and an agent. That is, the controller 124 may select the call center 130 that is geographically closest to the customer.

The controller 124 further selects an agent at the call center 130. The agent may be selected based on information within an agent profile 150, such as an issue capacity 151 of the agent (i.e., indicating a number of simultaneous issues that the agent can handle), languages 152 understood by the agent, a connectivity of the agent 153 (e.g., whether the agent is logged in or otherwise connected to issue coordination server 120), a geographical distance between a location 154 of the agent and a geographic location 161 of the customer, a manually set availability flag 155 indicating whether the agent is currently available, an effectiveness score 156 (e.g., AES) for the agent, a demographic of the agent, etc.

An agent profile 150 may also store other information such as a name and/or password for the agent, to facilitate secure login processes. In further embodiments, agent profiles 150 indicate the experience of each agent, and whether the agent is specialized to specific categories of issues. Thus, if a customer has encountered a specific issue, selection of an agent trained for the issue may be prioritized by controller 124. In further embodiments, an agent may be selected based on any suitable criteria indicated in an agent profile stored in memory 126 or at a server within the call center 130.

After an agent has been selected, controller 124 may upgrade a received request to form a secure connection between a customer device 110 and an agent device 132 via the issue coordination server 120. As used herein, an agent device 132 may be implemented similarly to a customer device 110, such as a laptop accessing a web or app chat application hosted by the issue coordination server 120 in real-time.

The secure connection may comprise an HTTP Secure (HTTPS) connection, a WebSocket connection (e.g., as discussed in Internet Engineering Task Force (IETF) Request for Comments (RFC) 6455, etc.). Controller 124 may facilitate the formation of a secure connection based on HTTP logic 177 and/or socket logic 178 in memory 126 and/or interface 122.

With an agent selected, the controller 124 enables a conversation by establishing a messaging stream (e.g., a web chat, Short Message Service (SMS) text exchange, email conversation, voice stream, video stream, etc.) between the agent device 132 and the customer device 110. As used herein, a conversation comprises messaging exchanged between the customer and the agent. In one embodiment, the messaging stream supports the exchange of textual messaging between the customer and the agent, and is compatible with a social-media specific type of chat application, such as a Facebook Messenger application. In a further embodiment, the messaging stream is serviced via WebSocket protocol, and may provide for full-duplex communications between the agent and the customer via the issue coordination server 120. Communications sent via the messaging stream may each be accompanied by metadata, such as an intended recipient of the message, a sender of the message, a timestamp that the message was sent, a department indicated by corresponding call center information, etc.

During the conversation, issue coordination server 120 monitors the messaging stream between the customer device 110 and the agent device 132 for content and timing data between messages and responses. The monitoring process may be tailored to the protocol used for the conversation. Thus, in embodiments wherein issue coordination server 120 utilizes different protocols to act as a message broker for conversations performed via different protocols, it may engage in separate monitoring techniques, using separate functions, for each protocol. In this embodiment, messages are stored in memory 126 as conversations 175. Each conversation 175 includes content 173, such as message text, as well as timing data 174, indicating the time at which the messages were generated, transmitted, captured at the issue coordination server, or received by the devices using the message stream.

Based on information about the conversations and effectiveness scoring criteria 172 maintained in memory, the controller 124 calculates an AES for the conversation. At the end of the conversation, the controller 124 updates the AES of the agent based on metrics for the conversation.

The processes discussed above may be performed concurrently, simultaneously, and/or asynchronously for thousands or even millions of issues and/or conversations at once, and may take real-time measurements of such conversations to levels of detail within a hundredth of a second or less. Hence these processes are not possible as a mere method of organizing human activity. Furthermore, these operations may be performed globally for call centers across the world, and for a variety of clients, such as across a vast computer network that utilizes one or more issue coordination servers 120 as specialized hardware having specialized instructions and onboard communications logic.

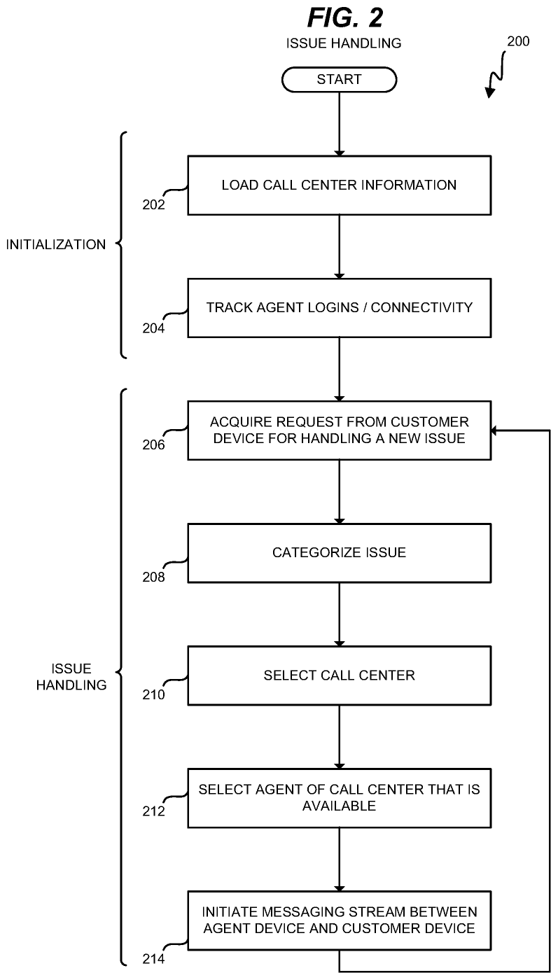

FIG. 2 is a flowchart illustrating a method 200 for operating an issue coordination server 120 to initiate a conversation between a customer and an agent in an illustrative embodiment. The steps of method 200 are described with reference to customer service network 100 of FIG. 1, but those skilled in the art will appreciate that method 200 may be performed in other systems. The steps of the flowcharts described herein are not all inclusive and may include other steps not shown. The steps described herein may also be performed in an alternative order.

According to method 200, step 202 includes controller 124 loading call center information from call center profiles 176 in memory 126. This may comprise accessing hours of operation of each call center 130 that is being considered, loading the agent profiles 150 for agents at each call center 130, a geographic location of each call center 130, etc.

Step 204 includes tracking agent logins and/or connectivity to issue coordination server 120. In one embodiment, agent logins are tracked in a registry in memory 126 in order to indicate agents that are actively logged into the issue coordination server 120. Connectivity data indicates whether an agent that is logged in has an active connection established with the issue coordination server 120, and/or the quality and type of protocols supported by the connection. For example, controller 124 may determine that a connection with an agent device 132 supports SMS or web chat messaging, while not supporting voice owing to bandwidth limitations.

With initialization having been completed, issue coordination server 120 enters an issue handling mode, wherein controller 124 actively identifies and services requests from customers, by selecting agents and establishing message streams between customers and those agents. Thus, although the issue handling steps provided below are discussed with regard to a single issue, it will be understood that these steps may be performed in parallel and/or asynchronously for a vast multitude (e.g., millions) of requests at once.

In step 206, interface 122 acquires a request from a customer device 110 for handling a new issue. As discussed above, the request may include identifying information for the customer or customer device 110. For example, the request may include a user identifier, phone number, handle, Internet Protocol (IP) address, or other identifying information. The request may also indicate the nature of the issue to be resolved. This information may be manually entered into the request by a customer, or may be generated automatically based on context or customer answers to preliminary questions (e.g., as provided in a form filled in by the customer on a web page, by answers to a chat bot, based on an address of a webpage that prepared the request, etc.).

The request itself may comprise an SMS message, HTTP POST or GET request, phone call, etc. HTTP network requests may be upgraded via a handshake with the issue coordination server 120 in order to form a secure connection via a WebSocket Secure (WSS) protocol.

In one embodiment, the request is associated with an issue history of the customer and/or the customer device 110, and indicates prior issues, satisfaction ratings, and/or message content for the customer relating to prior conversations.

In step 208, the controller 124 categorizes the issue. In one embodiment, this comprises identifying a product or service that the issue pertains to. Controller 124 may identify the product or service by reviewing metadata within the request, reviewing the title of the request, determining a referring website address, and/or via other means. In this embodiment, categorizing the issue also includes determining a complexity of the issue, referred to herein as an “issue complexity.” Issue complexity comprises a numerical value that influences the resulting AES that will be calculated for the conversation regarding the issue. In this embodiment, the issue complexity is determined partly by the associated product or service, and partly by keywords within the title or content of the request that indicate the issue with greater specificity. For example, an issue with a toaster may be considered less complex than an issue with a computer. Similarly, an issue with a computer keyboard may be considered less complex than an issue with a computer BIOS.

With the issue having been categorized in step 208, step 210 comprises selecting a call center 130. Call centers 130 may be filtered based on tags indicating their proficiency with different products or services. Controller 124 may then choose the call center 130 that is geographically closest to the customer, is open, and has at least a minimum level of proficiency with the associated product or service. In further embodiments, information within the call center profiles 176 is referenced by controller 124 to select a call center 130. The call center profiles 176 in this embodiment include geographical location of a call center 130, hours of operation for the call center 130, a number of agents at the call center 130, a listing of languages spoken by agents at the call center 130, rates charged by the call center 130 (or agents thereof), and/or other information. A call center profile 176 may also be updated in real-time based on communications with a call center 130, in order to indicate, in real-time, a list of agents that are logged in and available to handle issues for customers.

In a further embodiment, controller 124 of issue coordination server 120 performs multiple tiers of selection and filtering of call centers 130, in order to determine the best call center 130 for a given customer. In a first tier, controller 124 filters out call centers 130 that do not have proficiency with the product and/or issue determined for the customer. Call centers 130 will necessarily vary in the type of products and services that they specialize in providing support for. For example, call centers 130 may vary in expertise due to proximity to different client bases that each have specific regional and technological requirements and expectations.

This first tier of filtering takes advantage of the insight that when a customer makes a request, they are looking to solve a specific issue that is usually tied to a known product or service. By taking product and/or issue into consideration at the forefront, controller 124 ensures that the call center 130 which is eventually chosen will have the expertise needed to address the concerns of the current customer. This results in a call center-level implementation of “skill-based” routing, wherein customers are connected to agents who are subject matter experts.

In a second tier, controller 124 additionally filters out agents who are not proficient in a language used by the customer. The language used by the customer may be determined automatically based on an analysis of textual content included within the request. While issue coordination server 120 may include instructions in memory 126 for performing translation in real-time (e.g., for textual conversations), routing a customer to a regional call center having agents who speak the language of the customer is more likely to result in customer satisfaction. Specifically, same-language conversations tend to be more effective, while also ensuring that demographic differences relating to tone (e.g., curtness, playfulness, responsiveness, etc.) do not cause problems which could negatively influence customer sentiment.

In a third tier, controller 124 additionally filters our call centers based on characteristics of the customer stored in memory. These characteristics may comprise Net Promoter Scores (NPSs) for the customer, and/or a history of prior issues and/or products relating to the customer. Based on the characteristics of a customer, controller 124 may select a specialized call center. For example, if a customer has a history of being dissatisfied with the support provided for their inquiries, or is indicated in a profile as a Very Important Person (VIP), a specialized call center may be chosen that has additional expertise in a product or issue, is particularly expeditious, etc. For example, controller 124 may select a “high touch” call center to provide a customer with an additional level of service. High-touch call centers tend to be more expensive (due to additional agent training) and have fewer available agents, and hence allowing controller 124 to select such call centers only in response to detecting special characteristics of a customer helps to save cost.

In step 212, an agent from the call center 130 is chosen. An agent is chosen based on whether the agent is available. In one embodiment, this comprises selecting an agent that is logged in, connected, and that is not currently at capacity for handling issues. Furthermore, an agent may be selected based on their ability to interact in a language known by the customer. With the agent known, controller 124 accesses an agent device 132 (e.g., laptop, desktop, tablet, cellular phone, etc.) operated by the agent.

In further embodiments, agents are classified based on whether they are logged into the issue coordination server 120, currently connected to the issue coordination server 120, and/or available (e.g., under capacity). In still further embodiments, memory 126 stores information indicating languages spoken by agents, effectiveness scores of agents, a list of areas of expertise of agents (e.g., on a product-by-product or service-by-service basis), and other information. Any and/or all of this information, in any suitable combination, may be utilized to select the optimal agent at a point in time for servicing an issue for a customer.

In step 214, controller 124 initiates a messaging stream between the agent device 132 and the customer device 110. This results in a conversation, which continues until the issue has been resolved. Upon completion of the conversation and/or during the conversation, controller 124 tracks the responsiveness of the agent to messages from the customer. In one embodiment, effectiveness (e.g., AES) for a conversation is determined by based on a cost function. In this embodiment, the cost function is equal to the average of times between messages and responses, each time multiplied by a complexity weight assigned to the corresponding message. The overall value is then multiplied by a numerical issue complexity to arrive at a final value.

In further embodiments, data centers (e.g., specialized third party servers 140 or issue coordination server 120) are utilized to perform message brokering and/or store resource information for customers and/or agents that facilitates issue resolution during the conversation. The physical/geographic locations of these data centers may be chosen to enhance response times, on a client-by-client basis. For example, a datacenter pertaining to a first client may be located in Asia to facilitate response times for a customer base of that client, while a datacenter pertaining to a second client may be located in Asia to facilitate response times for a customer base of that client.

Agent Responsiveness Tracking

During and/or after the conversation, controller 124 may perform tracking and analysis of messages to facilitate the calculation or updating of an AES for the agent. Depending on embodiment, the tracking and analysis may take any suitable form described below.

In one embodiment, each agent response during a conversation is tracked to determine whether or not it is provided within a threshold period of time, but the threshold period is dynamically altered/configurable based on the method of communication, and may be adjusted on a message-by-message basis. AES is then scored as a percentage of responses for a conversation within the threshold for the method of communication (i.e., responses that are flagged as “acceptable” based on response time). In a further embodiment, the greater the amount of delay beyond the threshold period, the greater penalty applied for a response. Different methods of communication (e.g., text-based chat, SMS texts, voice calls, video calls, and/or email) may each be associated with a different threshold period in order to account for social norms and expectations. In some embodiments, this threshold period defines a baseline for expected response time, which is then modified by controller 124 dynamically based on conditions of the conversation that may change in real-time.

In one embodiment, the threshold period for responding is initially calculated (and periodically updated) by aggregating data across many conversations for each modality of communication, and then averaging initial agent response time in those modalities globally for an issue or product/service, or for all issues for all products/services. Calculating the threshold period in this manner may account for social expectations such as responding more quickly to voice calls and text-based chat in a web application than via SMS and email. That is, each protocol and/or medium used for brokering a conversation may have a different multiplier which adjusts the threshold period.

For certain issues, a customer may reach out with a question and receive a swift response from an agent. However, if the response is not meaningful or lacks substance, then a satisfactory response has not been given. Conversely, an agent may reply indicating that they are currently investigating and will need to be given some time. In both scenarios, the controller 124 may provide an interactive survey to indicate whether the response of the agent was satisfactory. In some embodiments, the survey is provided at the conclusion of the conversation, while in other embodiments, the survey is provided in real-time for one or more of the responses of the agent (e.g., via thumbs-up or down indicator presented proximate to the response).

Controller 124 may further dynamically modify a threshold period based on the number of conversations that an agent is currently engaged in. This accounts for the difficulty an agent may have in handling a variety of issues for a variety of different topics simultaneously. Thus, the threshold period for each conversation may be increased by a static amount, or multiplied by an amount greater than one, in order to account for the need to divide attentional resources across multiple customers (e.g., based on predetermined data tables in memory 126). These insights may be particularly relevant in situations wherein agents at a call center 130 are understaffed, and hence must accommodate a perpetually high volume of issues to handle. By alleviating some of this stress (in the form of relaxed threshold periods), controller 124 beneficially separates agent performance metrics from service delays caused by high volumes of issues. In still further embodiments, a similar multiplier may be utilized to provide agents with additional response time during peak service hours.

In further embodiments, controller 124 accounts for the existence of compound customer messages within a conversation. As used herein, a compound customer message comprises a series of multiple messages sent by a customer that are each within a predefined period of time of the prior message. Controller 124 treats these batches of messages as a single compound message that includes all of the content of the prior messages, and that was sent at the time of the last message. This prevents the agent from being penalized for not responding to earlier messages that were part of the compound message. Conversely, if controller 124 determines that the customer has sent multiple messages without an agent response, and those messages are each separated by more than the predefined period of time, the messages are deemed to be individual messages. In a further embodiment, the controller 124 adjusts the threshold period for responding to a message, by decreasing the threshold period if immediately prior messages have not been flagged as responsive. This encourages an immediate and substantive agent response.

In one example, in a text-based chat application operating on a browser, an additional input (or automated button) to submit feedback such as “(un)satisfactory response” or “awaiting response” is provided. This feedback is used to override the threshold period for an agent to respond. Thus, if an agent responds after the threshold period, but the customer indicates satisfaction, the response is flagged as acceptable for complying with the response time. Conversely, if an agent responds before the threshold period of time expires, but the customer indicates dissatisfaction, the response is flagged as not complying with the response time. These types of manual adjustments provided by customers provide call centers with insights that help to provide incentives for agents to respond in a cogent and complete manner. Hence, agents are penalized for providing trivial responses when complete responses are needed by a customer. This input from a customer can also be utilized by controller 124 as an indicator of whether a customer desires an immediate response or is content waiting for the agent to investigate.

In further embodiments, controller 124 engages in customer complexity analysis. Labor intensive or technically complex inquiries require additional time spent on the side of the agent. While an agent can respond with a simple message indicating that they will get back to the customer shortly, subsequent agent messages may be sluggish. To account for this, controller 124 may perform a complexity analysis of customer questions, using natural language or review for specific keywords. The higher the determined numerical complexity and/or longer the customer question, the higher the permitted response time threshold. In one embodiment, controller 124 adds a static amount of time to the threshold period, or multiplies the threshold period by an amount greater than one, based on the determined complexity and/or length (e.g., as indicated by a table or a trained machine learning model).

Natural Language Analysis

In one embodiment, complexity analysis is performed via natural language processing to pick out sentence segments or phrases that are matched to a preset library (or knowledge base) of articles, phrases, and terms. When one or more are matched (each being assigned a corresponding, preset complexity), a complexity index is generated by controller 124 which corresponds to a tangible threshold period extension. For example, the controller 124 may assign a complexity equal to the highest complexity phrase in a message from the customer, may add the complexities of recognized phrases in the message to determine an aggregate complexity, etc.

In further embodiments, natural language processing may be used to determine emotional tone. For example, controller 124 may recommend an emotional tone to the agent that is correlated with the issue for the conversation. Thus, if the issue is data loss, the agent may be encouraged to be conciliatory, while if the issue is billing, the agent may be encouraged to be professional and firm.

Natural language processing may include consideration of historical content, such as the unredacted textual content of prior conversations. This data may be sent to a singular linguistics engine, along with a post-conversation, customer-provided satisfaction score. Both the content and score may then be paired to enable the linguistics engine to associate specific terms, phrases, and message delay times (for the customer) with a particular score. The textual content may be paired with a score for each message, for each response, for each message and corresponding response, for the entire conversation, etc.

In one embodiment, the linguistics engine comprises a neural network in memory 126 that processes content in real-time from a customer, and has been trained with the historical content. In this embodiment, sentiment analysis may be performed immediately (i.e., as the conversation is occurring) and automatically (e.g., without requiring human intervention by a call center administrator). In such an embodiment, controller 124 may provide sentiment analysis feedback from the neural network to the agent device 132 in real-time to facilitate attention to the sentiment of the current customer as messaging is exchanged. This results in a feedback loop which ensures that the agent, who may be handling many conversations at once, can adjust their “touch” as customer sentiment improves or declines.

Additional content and scores may be fed into the neural network by controller 124 and used for re-training of the neural network in order to adjust connection weights between nodes at the neural network. This ensures that the neural network is always adjusting its internal model relating to customer behavior and outcomes. As the neural network is continuously fed new information (e.g., for thousands or millions of conversations per day), the real-time sentiment analysis performed by it becomes more accurate. An enhanced neural network model provides a technical benefit by better equipping agents to handle a variety of customers while maximizing customer satisfaction.

In one embodiment, customer sentiment is reported via a graphical depiction of mood, such as “emoji” or graphical depictions of faces expressing different moods (e.g., satisfied, unsatisfied, about to be unsatisfied, etc.). If a customer updates their graphical depiction, or language analysis detects a change in tone, suggesting a change to an unsatisfied state, controller 124 may alter the graphical depiction for the customer seen by the agent. Furthermore, if the agent is helping another customer, controller 124 may generate a ping or other cross-conversation notification to ensure that the agent is aware of the decline in satisfaction.

In one embodiment, controller 124 provides sentiment information to administrators at each call center 130, to indicate customers that are at risk of becoming unsatisfied. This enables the administrators to rapidly re-assign conversations between agents, or take other desired steps of remediation.

In a further embodiment, products are associated with each conversation, which enables administrators and agents to be aware of broader trends in sentiment relating to specific products and/or issues. For example, a particular product offering may be associated with a significantly higher number of requests. When this occurs, the call center can determine the aggregate customer sentiment for issues relating to the associated product. Controller 124 may then generate a notification to a client requesting updated issue handling procedures, and/or encourage agents to utilize curated content that will be the most effective in addressing the most common issues for the product.

In one embodiment, controller 124 sends notifications to agent devices 132 with this “trending” curated content to the side of a conversation window or panel for quick access. In this manner, an agent can send the content on to a customer without having to reach out to an administrator at the call center 130. In embodiments where the platform is online, new content can be managed by an administrator and propagated to the agents immediately via issue coordination server 120.

These processes facilitate the ability of controller 124 to perform customer sentiment monitoring, to account for the possibility of a customer growing weary or aggravated during a conversation. Again, by using natural language processing (e.g., as determined by a trained machine learning model), controller 124 may detect changes in tone that indicate dissatisfaction. Depending on the phrase of dissatisfaction, a different reduction in response time may be required. For example, a phrase containing an expletive may reduce the threshold period from a baseline value by a preset amount, or may multiply the baseline value by a fractional amount that is less than one to reduce the overall amount of time permitted for response. This ensures that an agent remains attentive to customers that require immediate attention in order to be soothed.

In further embodiments, customer sentiment is used to determine satisfaction of the customer with an agent response. If the sentiment for a customer message following an agent response indicates that the customer is agitated (e.g., as indicated by natural language analysis or the presence of expletives), then the quality of the agent response may be considered low or unsatisfactory, resulting in the agent response being flagged as unresponsive or noncompliant. In still further embodiments the threshold for using natural language analysis to determine that a customer is weary or aggravated may vary depending on the type of protocol used for the conversation. For example, conversations via voice may be expected to be less formal than those performed via email. Thus, controller 124 may require greater evidence of weariness or aggravation in a voice conversation than in an email conversation before concluding that the customer is indeed agitated.

Message Monitoring

Controller 124 may perform monitoring of messages on an intermediate (e.g., real-time) basis during a conversation, and/or may perform monitoring retroactively upon completion of a conversation. Examples of actions performed on an intermediate basis by the controller 124 include the following. In one embodiment, while a conversation is still occurring, the threshold response time is presented to the agent device 132 via the messaging stream by controller 124. This enables the agent to act dynamically to accommodate the needs of their current customers and messaging methods.

In a further embodiment, controller 124 increases a time threshold provided to an agent based on the agent performing specific actions, or controller 124 performs actions to facilitate agent response time. One such action is controller 124 providing a library, wiki, or other reference to an agent, with helpful information/topics to aid their pursuit of high customer satisfaction when servicing the issue. The selection of these references is performed by controller 124 based on a category of the issue, and/or the existence of articles that are tagged with a name of the issue. Another example includes controller 124 identifying agents that are not meeting a threshold percentage of response times for one or more conversations, and reducing a capacity of such agents. In a further embodiment, controller 124 determines that an agent has not reached a desired target for effectiveness (e.g., AES) during a conversation, and provides a notification to supervisors, managers, and/or leads of such agents to facilitate the provisioning of support and guidance while a conversation is ongoing. This provides a technical benefit by boosting morale and customer satisfaction outcomes.

Examples of actions performed retroactively by the controller 124 include recommending training of an agent, based on a technical level of the conversation and customer sentiment. For example, if an agent is handling an issue that has associated training materials, and the customer reports dissatisfaction in an exit survey, controller 124 may provide the agent access to the training materials in order to increase the expertise of the agent. Similarly, controller 124 may recommend coaching points/techniques to a call center lead to facilitate the building of a rapport with an agent and facilitate better outcomes for future issues. In another example, if a response was deemed particularly negative (e.g., by significantly missing a desired threshold period), controller 124 flags the conversation (or a portion thereof) for retroactive analysis. The conversation is then transmitted to quality assurance teams for review. When multiple conversations have unsatisfactory scores/outcomes with similar complexity/customer topics, the controller 124 may recommend training process/material improvements rather than explicit agent coaching.

In still further variations of method 200, issue coordination server 120 may transmit messages to all customers known to own a certain product or subscribe to a certain service. These messages may provide links enabling customers to initiate conversations with agents, and may be particularly beneficial when a product or service is subject to a potential recall, notable change, marketing campaign, etc.

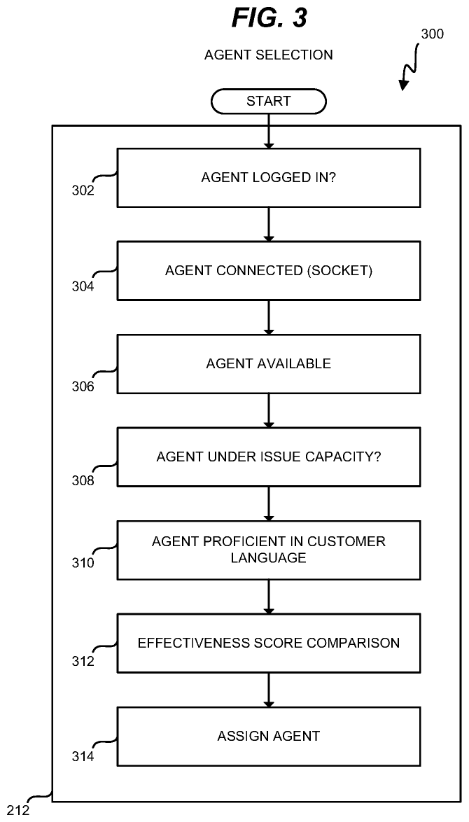

FIGS. 3-5 describe further illustrative implementations of the processes discussed with regard to FIG. 2. FIG. 3 is a flowchart depicting a method 300 of selecting an agent for a conversation in an illustrative embodiment. Method 300 may comprise an implementation of step 212 of method 200 performed by controller 124.

In this embodiment, method 300 includes determining that an agent has been logged into the issue coordination server 120 in step 302. An agent may log into the issue coordination server 120 by providing credentials to issue coordination server 120 via an agent device 132.

Step 304 comprises confirming that an agent (specifically, an agent device 132) is connected via a WebSocket connection to the issue coordination server 120. Step 304 may be performed by controller 124 reviewing identifiers of agent devices 132 that are connected via a WebSocket connection, and associating each agent device 132 with a specific agent (e.g., based on login information).

In step 306, a flag is checked to see whether the agent is available (e.g., based on manual input from the agent indicating that they are ready to receive work and are not taking a break). The flag may be manually set by the agent via an agent device 132 to update an agent profile 150, in order to indicate availability or lack thereof at the current moment.

In step 308, controller 124 determines whether the agent is under capacity. Step 308 may be performed, for example, by determining whether a number of active conversations for the agent is equal to or higher than the current number of conversations for that agent.

In step 310, controller 124 compares a profile for the agent to a profile for the customer to confirm that the agent is proficient in a language of the customer.

Step 312 includes comparing the AES of the agent to other agents in the call center who have met the criteria of steps 302-310. This may comprise controller 124 numerically ranking AES values for all available agents determined via steps 302-310. The agent with the highest AES is then assigned the issue in step 314.

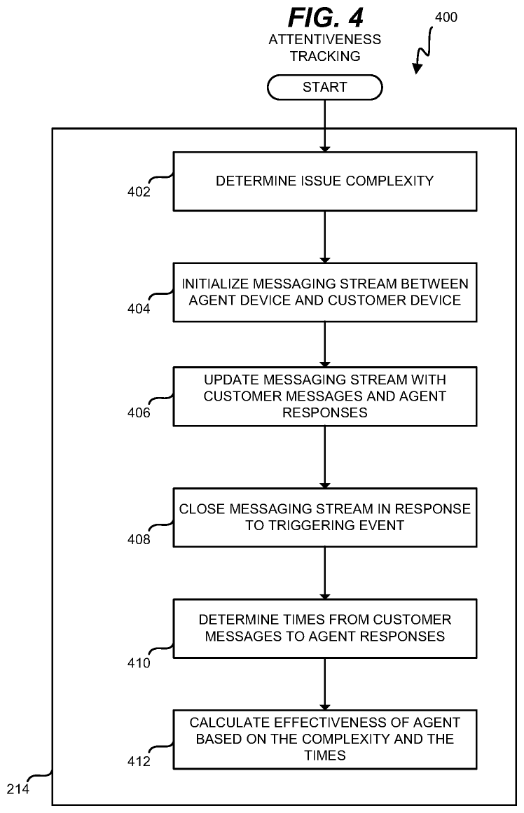

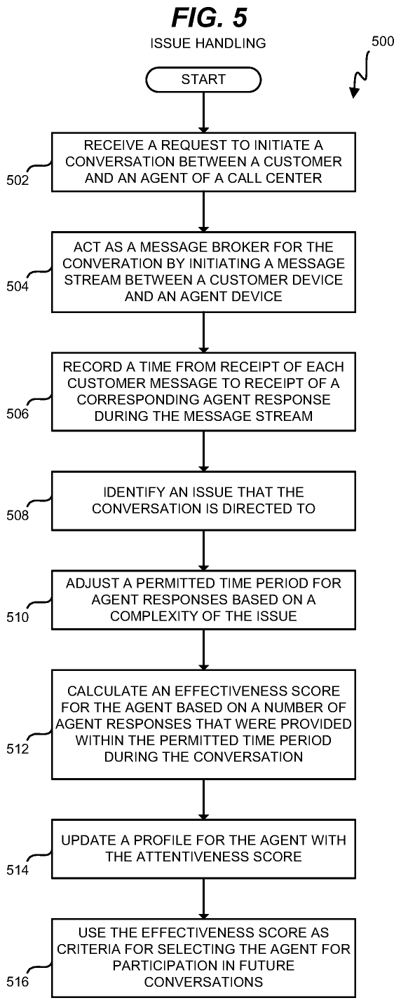

With an understanding of agent selection processes provided above, the discussion continues to FIGS. 4-5, describe various techniques related to effectiveness tracking. FIG. 4 is a flowchart depicting a method 400 of tracking an effectiveness score of an agent in an illustrative embodiment. Method 400 may comprise an implementation of step 214 of method 200 performed by controller 124.

Step 402 includes determining a complexity of the issue reported by the customer. In one embodiment, this comprises identifying keywords in the request from the customer device 110, and/or the product or service that the issue pertains to. In further embodiments, the complexity is increased based on a number of words describing the issue, and/or a reading comprehension level of the request determined via natural language analysis. Thus, a request that includes a message at a fifth grade reading comprehension level is provided with a lower numerical complexity than a request with a twelfth grade reading comprehension level.

Step 404 includes initializing a messaging stream between the agent device 132 and the customer device 110. In one embodiment, this comprises using WebSocket protocols to enables transmission of customer messages and agent responses via a text or picture stream between the devices. In step 406, the messaging stream is updated by controller 124 with customer messages and agent responses. By providing the messaging in real time to the agent and to the customer, both parties are capable of interacting with each other live in order to investigate and resolve the issue. Furthermore, because the issue coordination server 120 acts as the middleman in the messaging stream, it is capable of acquiring timing information more accurately than is possible via other techniques.

In some circumstances, an agent may sign off and exit the conversation before the issue has been resolved. In such circumstances, controller 124 may select a different agent for continuing the conversation with the customer, and initiate a new messaging stream between the newly selected agent and the customer.

In step 408, controller 124 closes the messaging stream in response to a triggering event. The triggering event may comprise the customer disconnecting from the messaging stream, a predefined period of idle time in the message stream, an instruction from the customer device 110 or agent device 132 to close the stream, an amount of packet loss in the messaging stream, and/or other criteria.

In step 410, controller 124 reviews the conversation within the messaging stream to determine the times between customer messages and agent responses. This step may be performed by independently detecting a customer message, then detecting a corresponding agent response to that particular customer message, and calculating a time between receipt of the customer message and transmission of the agent response. This process requires a complex system and scale that is simply impossible to be performed by hand, especially in an environment wherein hundreds, or even hundreds of thousands of conversations are being reviewed at once and on an ongoing basis, in order to provide real-time evaluations of agents.

In step 412, the controller 124 calculates an attentiveness/effectiveness score (e.g., an AES) of the agent during the conversation, taking into account issue and message complexity for the conversation. In one embodiment, this comprises determining the average response time of the agent, weighted based on an amount of textual content provided by the customer, a complexity of the issue, and other factors. In some embodiments, natural language analysis is performed on the request to determine the complexity, such as via a machine learning model. In further embodiments, complexity is determined via a predefined complexity table associated with the corresponding product or service.

FIG. 5 is a further flowchart depicting a method 500 of tracking an effectiveness score of an agent in an illustrative embodiment. Step 502 comprises receiving a request to initiate a conversation between a customer and an agent of a call center 130, and may be performed in the same manner as steps 206, 210, and 212 above.

Step 504 comprises acting as a message broker for the conversation by initiating a message stream between a customer device 110 used by the customer, and an agent device 132 of the agent, and may be performed in a similar manner to steps 404-408 above.

Step 506 comprises recording a time from receipt of each customer message to receipt of a corresponding agent response during the message stream, and may be performed in a similar manner to step 410 above. Additionally, the times of receipt may be measured as times that the issue coordination server 120 received the message and/or response, or times that a customer device 110 or agent device 132 provide a confirmation that a specific response or message have been received.

Step 508 comprises identifying an issue that the conversation is directed to, and may be performed as per step 208 of method 200. Step 510 comprises adjusting a permitted time period for agent responses based on the complexity of the issue. In one embodiment, this comprises selecting a weighted multiplier associated with the issue, and applying the weighted multiplier to the permitted time.

Step 512 includes calculating an effectiveness score for the agent based on a number of agent responses that were provided within the permitted time period during the conversation. Step 512 may be performed in accordance with the section titled “Agent Responsiveness Tracking” above. Furthermore, controller 124 may report to the agent, in real-time, whether each agent response was within the permitted time period (e.g., by color-coding responses from the agent, or adding icons to responses from the agent, etc.).

Step 514 includes updating a profile for the agent with the effectiveness score. For example, controller 124 may load an agent profile 150 for the agent, and average the effectiveness score for the conversation with other effectiveness scores for the agent for other conversations. This may be performed across all conversations for the agent, conversations for a specific product and/or issue, conversations during a specific time period (e.g., the last thirty days on a rolling basis, etc.), etc.

In step 516, controller 124 uses the effectiveness score as criteria for selecting the agent for participation in future conversations. This may be performed, for example, for all issues, for specific issues and/or products, etc. Controller 124 may use the effectiveness score as the sole criteria, or one of a combination of criteria for selecting the agent, as discussed above. In a further embodiment, controller 124 adjusts a capacity listed in an agent profile 150 of the agent indicating a number of permitted simultaneous conversations, based on the effectiveness score. For example, if the effectiveness score is above a first threshold, the capacity may be increased, while if the effectiveness score is below a second threshold (lower than the first threshold), the capacity may be reduced.

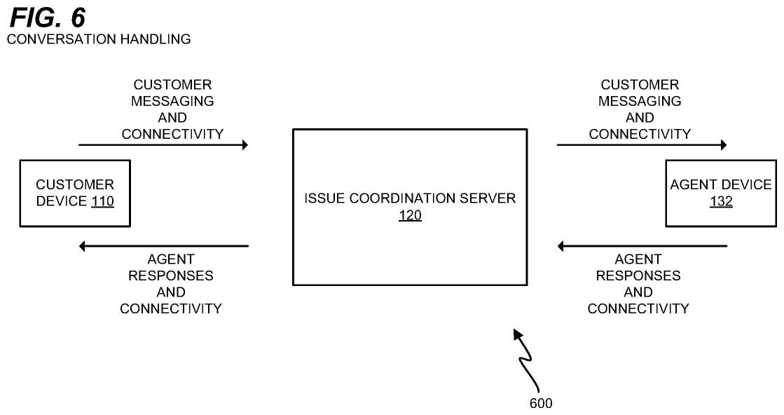

FIG. 6 is a schematic diagram 600 depicting an issue coordination server handling a conversation between an agent device and a customer device in an illustrative embodiment. In schematic diagram 600, a WebSocket messaging stream has been established by issue coordination server 120, and provides for transport of customer messages as well as agent responses (e.g., text and/or picture messaging, attachments, etc.) via the issue coordination server 120. In embodiments wherein WebSocket is utilized, stream data may be automatically populated and/or distributed in real time. Stream data may comprise messages and/or connectivity data, such as ping, latency, or other measurements. Alternatively, messaging by the customer device 110 and the agent device 132 may be directed to issue coordination server 120, which may then forward this messaging on to the intended recipient.

In one embodiment, an application at customer device 110, issue coordination server 120, and/or agent device 132 actively translates messages and/or responses such that recipients receive this data in a language that they are proficient in. This may enhance the ability for agents to provide service to customers, even in circumstances where an agent has no shared language with a customer.

By operating as a central nexus through which communications are routed, issue coordination server 120 is capable of monitoring the responsiveness of customers and agents for each conversation to within a fine level of detail (e.g., to within a hundredth of a second or less), and may even perform these operations in real-time on a message-by-message basis if desired.

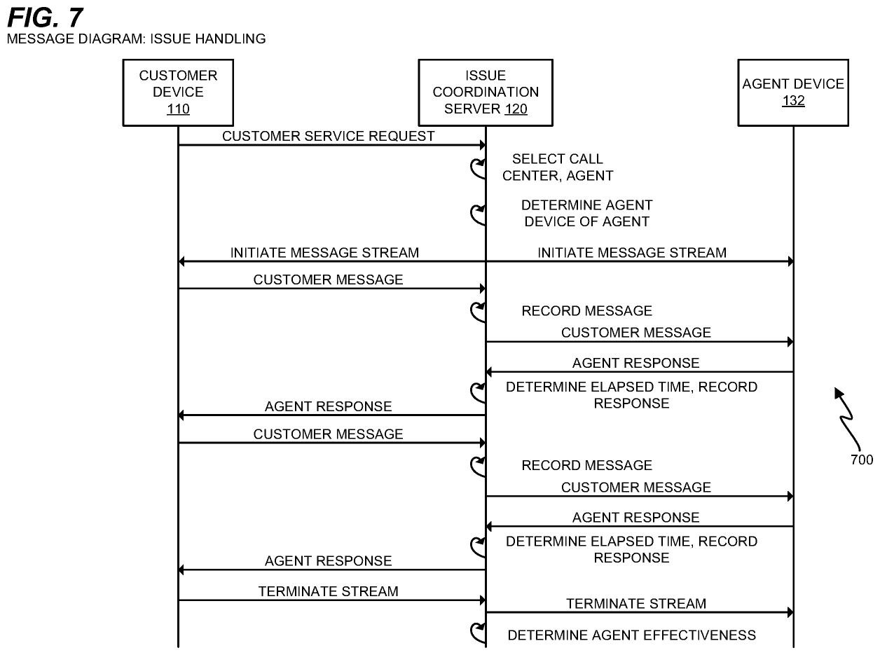

FIG. 7 is a message diagram 700 depicting communications with an issue coordination server during a conversation between an agent device and a customer device in an illustrative embodiment. Message diagram 700 provides greater detail of the operations of the various devices involved in a conversation than shown in schematic diagram 600 of FIG. 6.

As shown in FIG. 7, a customer device 110 initiates a conversation by generating and transmitting a customer service request. The customer service request may comprise a custom data format, such as an HTTP or WebSocket request that identifies the customer, the product or service, a title of the issue pertaining to the product or service, a geographical location of the customer, etc. Based on the request, issue coordination server 120 selects a call center 130 and agent for handling the issue. The issue coordination server 120 further determines contact information (e.g., an Internet Protocol (IP) address and port, etc.) for an agent device 132 of the agent.

With the agent device 132 identified, the issue coordination server 120 initiates WebSocket communications that establish a secure message stream between the customer device 110 and the agent device 132. With the secure message stream established, customer messages are provided from the customer device 110 to the agent device 132 via issue coordination server 120. Issue coordination server 120 records each customer message and agent response, as well as elapsed times between customer messages and agent responses.

Eventually, the customer either disconnects the customer device 110 from the stream, or sends a message explicitly terminating the stream. Based on this message, the issue coordination server 120 terminates the stream and marks the conversation as complete.

After the conversation is complete, the issue coordination server 120 scores the agent for effectiveness based on the timing of the responses of the agent, as well as the complexity of the issue and/or other factors. The controller 124 may further store the conversations (or redacted versions thereof, for example to omit medical and/or personal information) in memory 126. This enables conversations 175 to be retroactively analyzed in order to score the effectiveness (e.g., AES) of an agent. In one embodiment, controller 124 stores each conversation in memory 126 as message-response pairs, wherein each message-response pair indicates a time between a customer message and an agent response, a length of the customer message (e.g., in characters), and a length of the agent response (e.g., in characters).

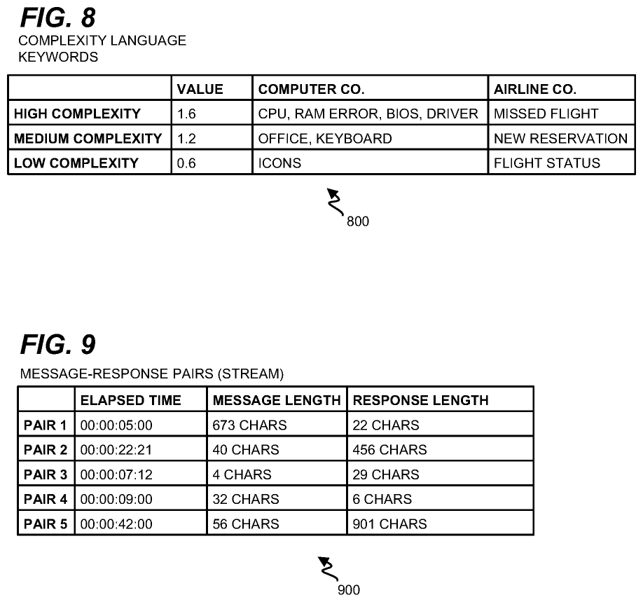

FIG. 8 depicts criteria 800 for identifying issue complexity in an illustrative embodiment. According to FIG. 8, issue complexity for different clients, such as a computer company or airline company, is identified based on the presence of keywords in the request received from a customer device. If a request includes a high complexity keyword (e.g., as indicated in a list received from the third party), then the issue is provided with a high value numerical complexity, as indicated by the corresponding numerical value. Alternatively, if the issue includes no high complexity keywords but does include a medium complexity keyword, it is provided with a medium value numerical complexity, and so on. Criteria 800 may be stored in memory 126 on a party-by-party, and/or product by product basis.

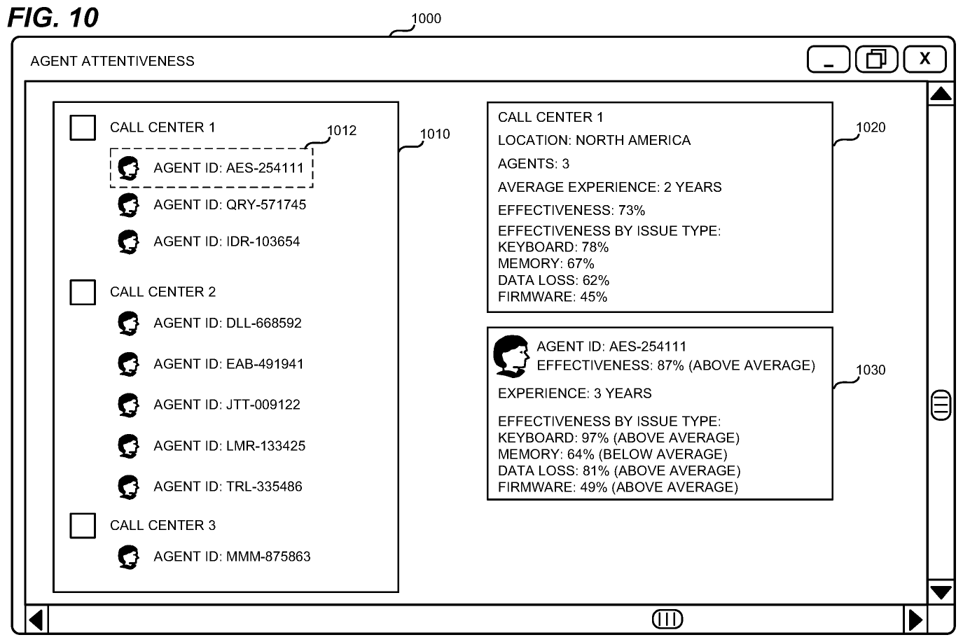

FIG. 9 depicts data 900 for tracking AES of an agent for a conversation in an illustrative embodiment. As shown in FIG. 9, messages from a customer are paired with responses from an agent. Each pair is associated with a time between the customer message and the agent response. Furthermore, a length of the customer message and agent response is stored. Thus, the complexity of interaction may be determined on a highly granular basis, per individual message pair. That is, a long message from a customer may require more time to respond to than a short message. Furthermore, by determining the length of agent responses, controller 124 may infer whether the agent has substantively responded to a message, or has rather simply acknowledged receipt of the message. For example, controller 124 may determine that all responses below a threshold amount of characters (e.g., five characters) are not responsive. Because the tracking of times is from customer message to agent response, it is possible for controller 124 to ignore times from receipt of an agent response to receipt of a customer message, if desired, to provide a technical benefit of reducing processing load.

In further embodiments, metrics and other data from conversations are stored by controller 124 in memory 126. This data may be utilized, for example, to facilitate training of a machine learning model. Controller 124 further generates aggregate data across conversations associated the same type of issue. For example, controller 124 may determine an average response time of an agent for each type of issue. Controller 124 may then adjust or alter the permitted time period used to calculate an effectiveness score for agents.

For example, controller 124 may apply a multiplier to the average response time for an issue, such as one-and-a-half times the average response time, ninety percent of the average response time, etc. in order to calculate a permitted time period for responding. These average response times may be determined globally, per client, per call center, for groups of agents having similar levels of experience (e.g., agents that have worked for a similar number of years in the field), or based on other criteria. This enables the permitted time period to be tuned to client, agent experience, call center, and/or other factors as desired.

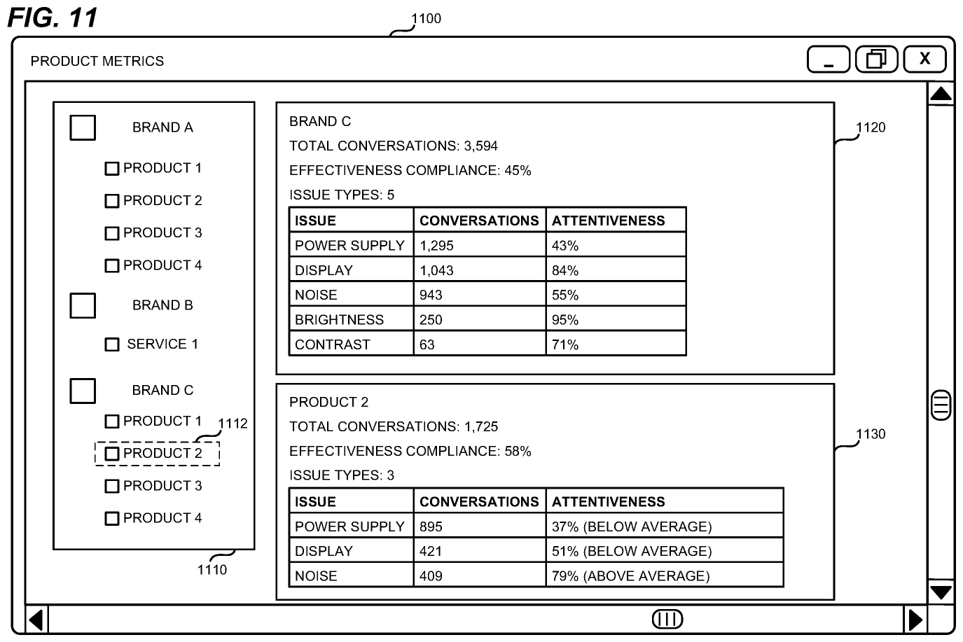

In one embodiment, controller 124 reports out conversation metrics to clients, which may be valuable for purposes of product development and quality assurance. FIGS. 10-11 depict GUIs that summarize customer service metrics in illustrative embodiments.

GUI 1000 of FIG. 10 may be utilized by an operator of a call center or issue coordination server 120 to determine the compliance of individual agents with effectiveness standards. In this embodiment, GUI 1000 includes a selection interface 1010, which lists the agents within each call center, and enables the selection of specific agents. In this embodiment, a selection 1012 of an agent is indicated with by highlighting the entry for the agent in the selection interface.

GUI 1000 also presents call center information, in area 1020. The area 1020 provides general information about the call center such as its location, number of agents, and average amount of agent experience. Area 1020 also provides a list (ordered alphabetically or numerically) that indicates the percentage of conversations for each issue handled by the call center that were compliant with effectiveness standards.

Area 1030 provides information detailing the performance of an agent selected by selection interface 1010. In area 1030, a unique identifier is provided for the agent, as well as an average effectiveness of the agent across all issues. The average effectiveness is the percentage of conversations handled by the agent that were compliant with effectiveness standards (i.e., within the response period and/or flagged as compliant based on customer input or sentiment). The agent's effectiveness (i.e., percentage of responses and/or conversations meeting with a threshold score for AES) is also listed for each type of issue, and is reported as above average, equal to, or below average as compared to other agents at the call center, or other agents of a similar experience level. In further embodiments, effectiveness of an agent may be reported per product or service, or using other metrics.

The information provided in GUI 1000 may be utilized by a call center in order to detect agents that are performing above or below average with regard to specific types of issues. In one embodiment, controller 124 determines that an agent's effectiveness for a particular issue is below a desired rate (e.g., eighty percent), and proceeds to transmit a notification to the corresponding call center 130, indicating a need for additional agent training on the issue. In this manner, agents who are not fully responsive for certain issues may receive additional training to ensure better responsiveness. In still further embodiments, agents having an average responsiveness below a threshold level (e.g., below average) may have their working hours reduced, or a number of simultaneously permitted conversations reduced. In a similar vein, agents having an average responsiveness above a threshold level (e.g., above average) may have their working hours increased, or a number of simultaneously permitted conversations increased.

GUI 1100 of FIG. 11 presents the most common issues encountered for individual products and brands. In this embodiment, GUI 1100 includes a product selection interface 1110, which lists the agents within each call center, and enables the selection of specific agents. In this embodiment, a selection 1112 of a product is indicated with by highlighting the entry for the product in the selection interface 1110.

GUI 1100 also presents brand information, in area 1120. The area 1120 provides general information about the brand, such as the total conversations pertaining to products in the brand, an overall effectiveness compliance of agents for conversations relating to the brand, the types of issues related to the brand, and an effectiveness compliance for each issue related to the brand, aggregated globally or for specific regions.

Area 1130 provides information detailing the performance of a product selected by selection interface 1110. In area 1130, a total number of conversations for the product are reported, as well as an average effectiveness compliance for the product across all conversations pertaining to the product. The number of attentive conversations is also listed on an issue-by-issue basis for the product. These amounts of effectiveness are reported as above average, equal to, or below average as compared to other products in the brand, or all other products offered by the client.

The information provided in GUI 1100 may be utilized by a client in order to determine the need for updated materials or procedures for handling calls related to specific issues for specific products. In one embodiment, controller 124 determines that effectiveness for a particular issue for a particular product is below a desired rate (e.g., seventy percent), and proceeds to transmit a notification to a customer device 110 operated by a client, indicating a need for updated reference materials and training for the product relating to the issue. In this manner, agents will be ensured access to the most relevant, most updated materials possible. This in turn helps to ensure that agents may be more responsive to customers.

### EXAMPLES

A specific implementation of the review process is discussed herein below, pertaining to an illustrative embodiment. In this embodiment, an AES is composed of two metric categories: conversation and customer. The two categories are evenly weighted, each with a maximum score of ten. The historical data is then selectively applied to modify these scores, depending upon whether historical data for a particular customer is present (i.e., new customers often do not have historical data). Consequently, historical data is used as a modifier which can potentially alter scores calculated for the two categories. Once scores for the two categories are calculated and modifiers are optionally applied based on historical data, the sum of values for the two categories is divided by two and rounded to the nearest integer to create a final, single AES score between zero and ten (with a ceiling of ten in the event that the modifiers cause a combined score of over ten).

The first category, conversation metrics, is calculated to arrive at a value between zero and ten. The value is based on an agent response time calculation and modified by agent capacity. The value is capped at ten even if modifiers cause the score to exceed ten. Agent response time may be calculated on a batched basis during or after a conversation, by determining the duration of time between the latest customer message and agent response. When customer messages are within ten seconds of each other, they are “batched” together as a “single” message. If the agent responds within thirty seconds of the batched customer message, the response is considered to be timely. The percentage of timely responses within a conversation is converted to a value between zero and ten (rounded to the nearest integer). For example, twenty-six timely responses out of thirty customer messages results in a percentage of 86.67%, corresponding to a conversation metrics value of nine.

The agent response time calculations may be modified based on agent capacity. When an agent is above their specified conversation capacity (e.g., when an agent is handling four conversations but has a listed capacity for three conversations), their value is calculated as a percentage of responses sent within sixty seconds (i.e., a different time threshold) of batched customer messages while over capacity. This helps accommodate for inherent ineffectiveness during periods of high volume, by providing additional time for an over-capacity agent to respond to a customer. In circumstances where an agent is over capacity, the percentage of timely responses is converted to a value between zero and ten (rounded down to the nearest integer) while over capacity. Thus, if three agent responses are timely during twelve over capacity customer responses, the result is 25% and the agent receives a score of two points out of ten.

The second category, customer metrics, comprise the sum of (1) a response time ratio and (2) an inquiry complexity, and is capped at a maximum value of ten. Response time ratio is a ratio of an Average Response Time (ART) of the customer to an ART of the agent, rounded to the nearest integer with a maximum value of ten. Thus, if the customer ART is ninety seconds and the agent ART is twenty seconds, then the response time ratio is 4.5 and the point value is five.

Inquiry complexity is calculated utilizing complexity language keywords as discussed elsewhere in the specification. The complexity language keywords provide the customer inquiry a point value. Low-complexity inquiries are assigned zero points, medium complexity inquiries are assigned two points, and high complexity issues are assigned four points.

In this embodiment, historical modifiers are only applicable if the customer is a returning one and has historical data. Historical modifiers in the form of prior customer satisfaction survey scores provided by the customer are calculated if such previous survey scores exist. In such cases, the survey scores set a precedent for the agent to effectively assist the customer. The resulting survey from a current conversation (if provided by the customer once complete) is compared to average survey results provided by the customer. The survey provides for a maximum of five stars. Hence, any deviation (rounded up to the nearest integer) between the current survey score and the average survey score is added or subtracted from the weighted score of the previous two categories. For example, if the average previous survey score provided by a customer was 3.5 and the new score is four, then the result is +0.5 and the agent receives one additional point on their overall summed score for the two categories.

The existence of open issues may also impact AES scoring. If a customer has existing, open issues, that are not yet resolved, this metric is designed to reward agents that resolve them. Thus, for every issue resolved (including the potentially new issue from the current conversation) during a conversation, a point is awarded and added to the overall summed score for the two categories.

Any of the various computing and/or control elements shown in the figures or described herein may be implemented as hardware, as a processor implementing software or firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

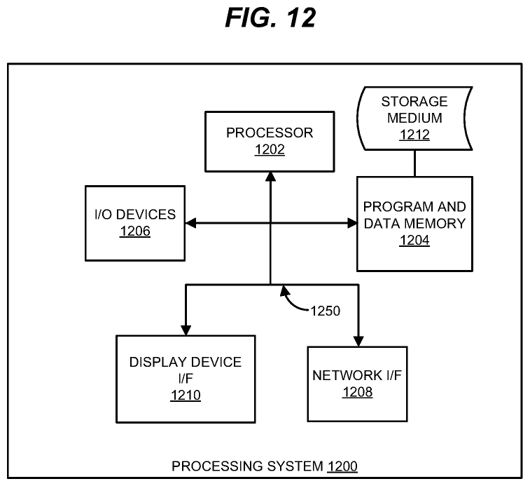

In one particular embodiment, instructions stored on a computer readable medium direct a computing system of issue coordination server 120 to perform the various operations disclosed herein. FIG. 12 depicts an illustrative computing system 1200 operable to execute a computer readable medium embodying programmed instructions. Computing system 1200 is operable to perform the above operations by executing programmed instructions tangibly embodied on computer readable storage medium 1212. In this regard, embodiments may utilize instructions (e.g., code) accessible via computer-readable medium 1212 for use by computing system 1200 or any other instruction execution system. For the purposes of this description, computer readable medium 1212 comprises any physical media that is capable of storing a program for use by computing system 1200. For example, computer-readable medium 1212 may be an electronic, magnetic, optical, electromagnetic, infrared, semiconductor device, or other non-transitory medium. Examples of computer-readable medium 1212 include a solid state memory, a magnetic tape, a removable computer diskette, a random access memory (RAM), a read-only memory (ROM), a rigid magnetic disk, and an optical disk. Current examples of optical disks include Compact Disk—Read Only Memory (CD-ROM), Compact Disk-Read/Write (CD-R/W), Digital Video Disc (DVD), and Blu-Ray Disc.

Computing system 1200, which stores and/or executes the instructions, includes at least one processor 1202 coupled to program and data memory 1204 through a system bus 1250. Program and data memory 1204 include local memory employed during actual execution of the program code, bulk storage, and/or cache memories that provide temporary storage of at least some program code and/or data in order to reduce the number of times the code and/or data are retrieved from bulk storage (e.g., a spinning disk hard drive) during execution.

Input/output or I/O devices 1206 (including but not limited to keyboards, displays, touchscreens, microphones, pointing devices, etc.) may be coupled either directly or through intervening I/O controllers. Network adapter interfaces 1208 may also be integrated with the system to enable computing system 1200 to become coupled to other computing systems or storage devices through intervening private or public networks. Network adapter interfaces 1208 may be implemented as modems, cable modems, Small Computer System Interface (SCSI) devices, Fibre Channel devices, Ethernet cards, wireless adapters, etc. Display device interface 1210 may be integrated with the system to interface to one or more display devices, such as screens for presentation of data generated by processor 1202.

What is claimed is:

1. A system comprising:
an interface configured to receive a request to initiate a conversation between a customer and an agent of a call center; and
a controller configured to act as a message broker for the conversation by initiating a message stream between a customer device and an agent device, and to record a time from receipt of each customer message to receipt of a corresponding agent response during the message stream,
the controller is further configured to identify an issue that the conversation is directed to, to adjust a permitted time period for agent responses based on a complexity of the issue, to calculate an effectiveness score for the agent based on a number of agent responses that were provided within the permitted time period during the conversation, update a profile for the agent with the effectiveness score, and use the effectiveness score as criteria for selecting the agent for participation in future conversations.

2. The system of claim 1 wherein:
the controller is further configured to store the conversation in memory as message-response pairs, wherein each message-response pair indicates a time between a customer message and an agent response, a length of the customer message, and a length of the agent response.

3. The system of claim 1 wherein:
the controller is further configured to determine the complexity of the issue by identifying a set of keywords in the request, consulting correlations in memory between keywords and complexities, identifying a highest complexity correlated with the set of keywords, and assigning the highest complexity to the issue.

4. The system of claim 1 wherein:
the message stream is implemented via a WebSocket protocol, and enables transmission of customer messages and agent responses that are textual.

5. The system of claim 1 wherein:
the controller is further configured to ignore times from receipt of an agent response to receipt of a customer message.

6. The system of claim 1 wherein:
the controller is further configured to adjust a capacity listed in a profile of the agent indicating a number of permitted simultaneous conversations, based on the effectiveness score.

7. The system of claim 1 wherein:
the controller is further configured to report to the agent, in real-time, whether each agent response was within the permitted time period.

8. A method comprising:
receiving a request to initiate a conversation between a customer and an agent of a call center;
acting as a message broker for the conversation by initiating a message stream between a customer device and an agent device;
recording a time from receipt of each customer message to receipt of a corresponding agent response during the message stream;
identifying an issue that the conversation is directed to;
adjusting a permitted time period for agent responses based on a complexity of the issue;
calculating an effectiveness score for the agent based on a number of agent responses that were provided within the permitted time period during the conversation;
updating a profile for the agent with the effectiveness score; and
using the effectiveness score as criteria for selecting the agent for participation in future conversations.

9. The method of claim 8 further comprising:
storing the conversation in memory as message-response pairs, wherein each message-value pair indicates a time between a customer message and an agent response, a length of the customer message, and a length of the agent response.

10. The method of claim 8 further comprising:
determining the complexity of the issue by identifying a set of keywords in the request;
consulting correlations in memory between keywords and complexities;
identifying a highest complexity correlated with the set of keywords; and
assigning the highest complexity to the issue.

11. The method of claim 8 wherein:
the message stream is implemented via a WebSocket protocol, and enables transmission of customer message and agent responses that are textual.

12. The method of claim 8 further comprising:
ignoring times from receipt of an agent response to receipt of a customer message.

13. The method of claim 8 further comprising:
adjusting a capacity listed in a profile of the agent indicating a number of permitted simultaneous conversations, based on the effectiveness score.

14. The method of claim 8 further comprising:
reporting to the agent via the message stream, in real-time, whether each agent response was within the permitted time period.

15. A non-transitory computer readable medium embodying programmed instructions which, when executed by a processor, are operable for:
receiving a request to initiate a conversation between a customer and an agent of a call center;
acting as a message broker for the conversation by initiating a message stream between a customer device and an agent device;
recording a time from receipt of each customer message to receipt of a corresponding agent response during the message stream;
identifying an issue that the conversation is directed to;
adjusting a permitted time period for agent responses based on a complexity of the issue;
calculating an effectiveness score for the agent based on a number of agent responses that were provided within the permitted time period during the conversation;
updating a profile for the agent with the effectiveness score; and
using the effectiveness score as criteria for selecting the agent for participation in future conversations.

16. The non-transitory computer readable medium of claim 15, wherein the instructions are further for:
storing the conversation in memory as message-response pairs, wherein each message-value pair indicates a time between a customer message and an agent response, a length of the customer message, and a length of the agent response.

17. The non-transitory computer readable medium of claim 15, wherein the instructions are further for: determining the complexity of the issue by identifying a set of keywords in the request;
consulting correlations in memory between keywords and complexities;
identifying a highest complexity correlated with the set of keywords; and
assigning the highest complexity to the issue.

18. The non-transitory computer readable medium of claim 15, wherein:
the message stream is implemented via a WebSocket protocol, and enables transmission of customer message and agent responses that are textual.

19. The non-transitory computer readable medium of claim 15, wherein the instructions are further for:
ignoring times from receipt of an agent response to receipt of a customer message.

20. The non-transitory computer readable medium of claim 15, wherein the instructions are further for:
adjusting a capacity listed in a profile of the agent indicating a number of permitted simultaneous conversations, based on the effectiveness score.
